(19) United States
(12) Patent Application Publication
(10) Pub. No.: US 2010/0100485 A1
(43) Pub. Date: Apr. 22, 2010

(54) System for the safe, private transmission of motor vehicle records

(76) Inventor: Mark Haddy, Yuba City, CA (US)

Correspondence Address: SHUMAKER LOOP & KENDRICK, 101 E. KENNEDY, SUITE 2800, TAMPA, FL, 33672-0609, US

(21) Appl. No.: 12/288,435

(22) Filed: Oct. 20, 2008

(51) Int. Cl. G06Q 40/00; G06F 21/00

(52) U.S. Cl. 705/51; 705/4

(57) ABSTRACT

The present invention is a method which can be used to select an insurer, such as for a motor vehicle operator. The method comprises the use of an agent interface and an MVR bridge for receiving motor vehicle record data from multiple sources and calculating insurance rates while minimizing the potential for compromising the privacy of the motor vehicle operator.

### BACKGROUND

Prospective insurers have found that an individual's MVR is a sound indicator of the magnitude of insurable-incident risk associated with a given individual. The MVR contains information relating to number, type and severity of moving violations, as well as prior accidents, motor vehicle charges and convictions. It is believed that such incidents are predictors for individual behaviors or propensities which correlate with high occurrence of insurable incidents, reducing the cost-effectiveness of insuring the individual. For example, a person who has a tendency to drive faster than the posted speed limit may have a propensity for recklessness which results in accidents yielding damage to the individual's vehicle as well as to other vehicles. One whose address corresponds to a crime-ridden part of town may be likely to suffer vandalism incidents. One who drives only late model, desirable, or costly vehicles may be likely to report even the most minor damage detracting from the appearance of their automobile, or they may present an elevated theft risk. One who has been driving for only a short time may not be as mature and experienced a driver, possibly possessing faulty judgment leading to an elevated risk of accidents and the attendant damage to their own vehicle as well as to other vehicles.

However, because the motor vehicle record contains a wealth of specific identifying information about an individual, it is an identity-sensitive document which is attractive to identity thieves. Among the pieces of information which may included within the motor vehicle record are an individual's name, social security number, birth date, driver's license state, driver's license number, previous addresses, motor vehicle moving violation and accident information, and other identity-sensitive pieces of information. Because the motor vehicle record contains such specific information useful in identity theft crimes, a criminal market exists for motor vehicle records. Methods for transferring the information such as mail, fax or e-mail attachment are all susceptible to interception. Each involves the transmission of a photocopy which can be obtained and read by any of the people involved in the transmission. Furthermore, such methods also generally involve the storage or filing of the MVR, raising the potential of access after transmission.

In addition to identity theft concerns, simple privacy concerns are an issue. The request of a prospective coveree to an insurance agent is a private act, and the prospective coveree would almost certainly prefer that the risk of the request becoming generally known be minimized. Furthermore, the identity of the prospective insurers receiving the MVR and their evaluation of the motor vehicle record in the form of quote could also be considered private information; the prospective coveree would likely prefer insurers not “converse” among themselves with regard to the prospective coveree's record. Each prospective insurer would likely prefer that its quote with respect to a particular prospective coveree's record be kept confidential and out of the hands of other prospective insurers as each has its own proprietary method for evaluating a given record.

In addition to identity theft and privacy concerns, efficiency concerns are an issue. Often, a prospective coveree has held a driver's license in multiple states. Each state has its own Department of Motor Vehicles, each of which will have a motor vehicle record corresponding to the prospective coveree. The consolidation of the records is a step which must take place in order for an insurer to begin evaluating and ultimately issue a quote.

### BRIEF DESCRIPTION OF THE DRAWINGS

FIG. 1:

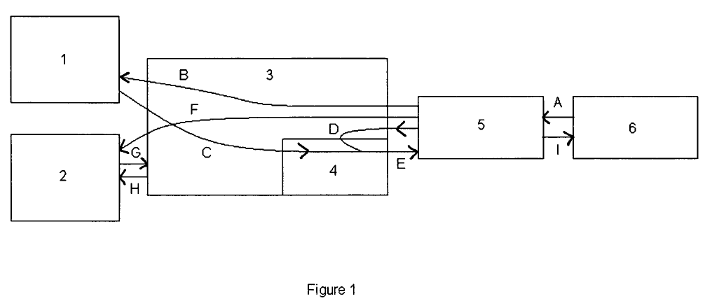

1) MVR Sources;

2) Insurers;

3) MVR Bridge;

4) Rater;

5) Agent; and

6) Prospective Coveree.

### DESCRIPTION OF THE INVENTION

A method for the generation of insurer quotes which keeps a prospective coveree's motor vehicle record from falling into outside hands, which maintains the privacy of an insurer's quote generation methods, the resulting quotes and the record request, and which facilitates the consolidation of motor vehicle information would likely be welcomed by insurers, agents, and prospective coverees.

The present invention is a method, for selecting an insurer, which facilitates the secure, direct transfer of motor vehicle records from a motor vehicle agency such that the records can be evaluated according to insurability standards of multiple insurers, resulting in insurability quotes corresponding to the insurers, from which an agent can determine the best insurer for a prospective coveree.

The present invention comprises software which communicationally connects elements comprising one or more insurance agents, one or more insurers and one or more motor vehicle record sources. The software comprises an MVR bridge. The MVR bridge is a means for receiving MVR data from MVR sources, as well as transmitting MVR data to insurers. The MVR bridge comprises rater software (the “rater”) such as that available from FSC Insurance Solutions.

The rater comprises rate-calculating algorithms corresponding to at least one insurer. While most insurers may use similar methods for evaluating an MVR record, the methods generally do not weight considerations exactly alike. For example, in evaluating a record for the purpose of generating a quote, one insurer may place a heavier reliance upon motor vehicle accident history than another insurer, which chooses instead to emphasize, for example, moving violations. Thus, most insurers for which the rater is capable of calculating a quote generally correspond to a unique algorithm or calculation method. Thus, by “algorithm” I meant the way a particular insurer utilizes the data in an MVR to arrive at a quote. By “quote” is meant the financial arrangement with a prospective coveree as the price of coverage by the insurer. Thus a quote can comprise, for example, payment amounts and payment schedules. Furthermore, the algorithms may not operate on all parameters of the MVR but only a subset of the MVR parameters. For example the algorithm for one insurer may not operate on parking violations, where the algorithm for another insurer may include parking violations in its corresponding algorithm. Moreover, the algorithm may choose to disregard certain parameters if certain other conditions are met. For example, an algorithm may choose to disregard moving violations if they are over three years old.

The quote-generating algorithms comprising the rater enable the rater to operate on parameters from the motor vehicle record and generate quotes for insurance companies which have corresponding algorithms entered into the rater. As indicated above, the algorithms for different insurance companies may be different, and certain MVR parameters may be excluded, conditionally if need be, depending on the preferences of the particular insurer.

Moreover, in one embodiment, one or more of the rate-calculating algorithms comprising the rater operate on parameters which are not part of the MVR. For example, the motor vehicle record may not include the prospective coveree's latest car model and year due to a gap in information due to for example, a cessation of driving or car ownership. For similar reasons, it is possible that the prospective coveree's motor vehicle record information does not include a latest residence address. Non-MVR information can comprise at least one automobile model, at least one automobile model year, and at least one geographic location of residence, or other information not present in the most recent motor vehicle reports. Other pieces of information about the prospective coveree which are not part of the MVR may also be necessary for an insurer to consider insuring a prospective coveree. In one embodiment the algorithm corresponding to at least one insurer has the capability of acting on parameters which are not part of a motor vehicle record. In one embodiment, the rater gives a conditional quote in the absence of required data which is not part of the MVR and which is not otherwise supplied, such as by the agent. In one embodiment the conditional quote is dependent upon assumptions about the missing pieces of information, such as assumed values (a “value” as used herein can be numerical; bimodal such as “yes” and “no”; or other designations which correspond to an unknown in an algorithm). In another embodiment, the “quote” is actually the dependence of the value on a continuous or discrete range of values corresponding to a parameter. In yet another embodiment, the quote is based upon an average value of the parameter. In another embodiment, the assumptions are specified with the quote. In a preferred embodiment, the agent supplies to the rater the necessary non-MVR information.

Generally, the rater comprises algorithms corresponding to more than one insurer. In one embodiment, at least one of the rater algorithms is a customized alteration of a standard rater algorithm.

In general, as the invention is used to select an insurer, the agent will review the quotes from more than one insurer. The agent selects the insurer based upon a criteria for evaluating the quote which can include, among other things, the quote having the lowest numerical value or the lowest cost based upon quotes from participating insurers. In one embodiment, an insurer may give multiple quotes, such as in the case of an insurer offering multiple coverage plans, each having different coverage details and thus different premiums.

The MVR bridge communicationally connects an agent with sources of Motor Vehicle Records. Such sources can comprise Departments of Motor Vehicles, as well as other public source of motor vehicle information, particularly sources having information of interest to an insurer in the assessment of motorist insurability. Thus in one embodiment, such sources also include public agencies such as Parking Violations Bureaus and Law Enforcement agencies. In one embodiment, the MVR bridge is communicationally connected to or has the ability to communicationally connect to Departments of Motor Vehicle Records.

The process of obtaining a quote which is most appropriate for a particular prospective coveree begins when an agent requests an MVR from one or more MVR sources. In a preferred embodiment, the agent interacts with the system by operating a desktop application. In other embodiments, the agent interacts with the system via a remote handheld device, such as a Blackberry™ or other device into which the request can be keyed or otherwise entered. The MVR data is requested through the MVR bridge. The MVR bridge integrates with the rater the ability to request data from MVR sources. The request is routed to the one or more MVR sources via the MVR bridge. In one embodiment, the MVR bridge is communicationally connected to Motor Vehicle Departments in one or more states, and the request goes out to all of the one or more states. In another embodiment, the agent makes a request to one or more states, and upon receiving the request, the MVR bridge establishes communicational connection with the Motor Vehicle Departments in those states. In yet another embodiment, the states in the foregoing two embodiments comprise the states in which the prospective coveree has established residence in the past, and optionally, the state in which the prospective coveree presently resides. In yet another embodiment, the MVR bridge establishes the communication connection with the Motor Vehicle Departments in a group of states upon a request from an agents, and the upon the agents issuing of a request, and the agent follows the request with a designation of states from which data is to be received.

In response to the agent request, the rater receives MVR data from the one or more MVR sources. In one embodiment, the one or more sources comprise at least one Motor Vehicle Agency. In a preferred embodiment, the rater is automatically populated with the MVR data as it is sent from the one or more MVR sources. In another embodiment, the data is received by an intermediate entity, which may or may not be part of the MVR bridge, and which enters the data into the rater. In one embodiment, the MVR data entered into the rater is preprocessed prior to entry. In another embodiment, the data automatically populating the rater is raw data, i.e., in the same form as contained in the MVR.

After the rater is populated with data, it generates quotes corresponding to specific insurers. In one embodiment, quotes are generated which correspond to all insurance companies whose quotes can be generated by the rater. In another embodiment, prior to quote generation, the agent identifies a specific insurer, and the quote(s) generated by the rater comprise the quote corresponding to the specific insurer.

Upon identifying a specific insurer as the most appropriate candidate to insure the prospective coveree, the agent, through an interactive application (for non-limiting example, desktop or Blackberry™) transmits the prospective coveree's MVR to the insurer. The MVR is sent via the rater data channel or other data channel associated with the MVR bridge. In one embodiment, the agent transmits the MVR by directing the MVR bridge to transmit the MVR and indicating to the MVR bridge the insurer to whom to transmit. In another embodiment, the agent is in receipt of the MVR (i.e., the MVR leaves the MVR bridge) and in order to transmit the MVR to the appropriate insurer, the agent subsequently loads the document into the MVR bridge and directs the MVR bridge to transmit the MVR to the appropriate insurer. In one embodiment, data from the MVR datafields is transmitted to the insurer. In another embodiment, all data from the MVR is sent in the appropriate fields. In another embodiment, an image file of the actual MVR is sent. In a preferred embodiment, the MVR is sent as a BLOB attached to an insurance application.

In a preferred embodiment, the MVR bridge encrypts the MVR at a time prior to transmitting it to the insurer. The encryption may take place at a time prior to the population of the rater with MVR data, such as, for example, at the time the data first reaches the MVR bridge. In another embodiment, the data is encrypted by the MVR-bridge prior to transmission to the insurer. For example, the data can be encrypted at such a time as the agent directs the MVR bridge to send the MVR data to one or more insurers. In the embodiment in which the MVR received from the MVR source(s) is loaded into the MVR bridge, encryption of the MVR by the MVR bridge may take place at any time prior to transmission to the insurer.

Once an insurer has received an encrypted MVR, the insurer may request an encryption key from an outside entity, i.e., the originators of the MVR bridge technology. In one embodiment, the encrypted MVR is unencrypted by the originators of the MVR bridge technology. In another embodiment, the originators of the MVR bridge technology transmit, by appropriate means, an unencryption key to the insurer. Once the MVR is unencrypted, the MVR data populates the insurer's system, whether by entry or automatically.

Illustrated in the FIGURE is a preferred embodiment. A prospective coveree approaches an insurance agent with a request for coverage, indicated by arrow A. The insurance agent sends a request for the prospective coveree's MVR to the MVR sources through the MVR bridge, designated by arrow B. In a preferred embodiment, the request is entered into a desktop interface. Although not indicated by the drawing, the request can optionally involve rater software, and thus the arrow would appropriately travel through the rater in the FIGURE. The MVR sources respond to the request by sending MVR data, in one embodiment through the MVR bridge, to the rater, resulting in the rater being populated by MVR data. In one embodiment, the MVR sends the data, which populates the rater, and in another embodiment, the MVR bridge processes what is received from the MVR sources such that the rater can be populated. The step is denoted by arrow C. The rater then generates quotes, arrow E. In one embodiment, the agent supplies, at a time prior to quote generation, non-MVR data, which is used in the generation of the quote. See arrow D. The agent reviews the quotes generated by the rater. In one embodiment, the review occurs via a desktop interface through which the request for MVR was entered. The agent selects a quote corresponding to an insurer. The prospective coveree's MVR is sent to the insurer, designated by arrow F. In one embodiment, the agent directs the MVR bridge, through a desktop application, to send the MVR to the insurer. In a preferred embodiment, the MVR bridge encrypts the MVR at a time prior to sending it to the insurer. The insurer requests an MVR decryption key, arrow G, and the MVR bridge supplies, or enables the supply, of the decryption key arrow H. At a time after receiving the quote, the agent contacts the prospective coveree to relay the quote and the name of the prospective insurer.

1. A method for determining an insurance rate for an insurance carrier for an individual, said method comprising the steps of:
a) obtaining identifying information for the individual;
b) supplying an MVR bridge, said bridge in communication with one or more sources of motor vehicle record data, said bridge comprising a rater, wherein said rater comprises at least one quote-generating algorithm corresponding to at least one insurer;
c) submitting the identifying information to one or more of said one or more sources of motor vehicle record data;
d) submitting a motor vehicle record request for one or more data from one or more records corresponding to said individual;
e) receiving, via the rater, the one or more records as electronic documents, or as entries which populate the rater;
f) if records in e) are received as electronic documents, populating the rater;
g) submitting non-motor vehicle record information to the rater;
h) allowing the rater to generate insurance rate quotes corresponding to at least one insurer.

2. A method as in claim 1 wherein c) and d) take place simultaneously.

3. A method as in claim 1 wherein said rater comprises at least two quote-generating algorithms corresponding to at least two different insurers, and wherein the method further comprises the step of choosing an insurer.

4. A method as in claim 1 wherein the one or more motor vehicle records are received in encrypted in format.

5. A method as in claim 1 wherein the one or more motor vehicle records are received in unencrypted format.

6. A method as in claim 4, wherein the method further comprises the step of transmitting the encrypted motor vehicle record via the rater to an insurer.

7. A method as in claim 3 further comprising the step of encrypting the motor vehicle record.

8. A method as in claim 7 further comprising the step of transmitting the encrypted motor vehicle record via the rater to an insurer.

9. A method as in claim 1 wherein insurance rates are generated for multiple insurers.

10. A method as in claim 9 wherein the insurance rates generated by the rater are compared and an insurance carrier is selected based upon the comparison.

11. A method as in claim 1 wherein the method further comprises the step of transmitting the encrypted motor vehicle record via the rater to an insurer.

12. A method as in claim 8, wherein the insurer to whom the motor vehicle record is sent is selected from one of two or more having corresponding algorithms comprised by the rater.

13. A method as in claim 12, wherein the insurer to whom the record is sent is an insurer having the lowest rate calculated by the rater.

14. A method as in claim 12, wherein the insurer to whom the motor vehicle record is sent is an insurer other than the insurer having the lowest rate calculated by the rater.

15. A method as in claim 13 or 14, wherein the insurer to whom the record is sent requests a decryption key.
